(19) United States
(12) Patent Application Publication
(10) Pub. No.: US 2025/0259081 A1
(43) Pub. Date: Aug. 14, 2025

(54) NEURAL TAXONOMY EXPANDER

(71) Applicant: Pinterest, Inc., San Francisco, CA (US)

(72) Inventors: Emaad Ahmed Manzoor, Pittsburgh, PA (US); Rui Li, San Jose, CA (US); Dhananjay Shrouty, San Francisco, CA (US); Jurij Leskovec, Stanford, CA (US)

(73) Assignee: Pinterest, Inc., San Francisco, CA (US)

(21) Appl. No.: 19/193,558

(22) Filed: Apr. 29, 2025

Related U.S. Application Data
(63) Continuation of application No. 16/592,115, filed on Oct. 3, 2019, now Pat. No. 12,307,382.

(51) Int. Cl. G06N 5/022; G06N 3/04; G06N 3/08

(52) U.S. Cl. CPC G06N 5/022; G06N 3/04; G06N 3/08

(57) ABSTRACT

Systems and methods for automatically placing a taxonomy candidate within an existing taxonomy are presented. More particularly, a neural taxonomy expander (a neural network model) is trained according to the existing, curated taxonomic hierarchy. Moreover, for each node in the taxonomic hierarchy, an embedding vector is generated. A taxonomy candidate is received, where the candidate is to be placed within the existing taxonomy. An embedding vector is generated for the candidate and projected by a projection function of the neural taxonomy expander into the taxonomic hyperspace. A set of closest neighbors to the projected embedding vector of the taxonomy candidate is identified and the closest neighbor of the set is assumed as the parent for the taxonomy candidate. The taxonomy candidate is added to the existing taxonomic hierarchy as a child to the identified parent node.

### RELATED APPLICATIONS

This application is a continuation of and claims priority to U.S. patent application Ser. No. 16/592,115, filed Oct. 3, 2019 and entitled “NEURAL TAXONOMY EXPANDER,” the entirety of which is incorporated by reference herein.

### BACKGROUND

Taxonomy is the science of defining groups. Elements of a taxonomy are typically located within a hierarchical organization on the basis of shared characteristics, and also names given to those groups. Traditionally, the general concept of a “taxonomy” was focused on the placement of biological organisms into a general hierarchy. The organisms are grouped together into taxa (singular: taxon) and these groups are given a taxonomic rank. Groups of a given rank can be aggregated to form a super group of higher rank, thus creating a taxonomic hierarchy.

Whether it is a matter of overloading the term “taxonomy”, or a matter of co-opting the general idea of taxonomy, the notion of taxonomy is frequently used in the context of computers. One particular use, and the general subject of the disclosed subject matter, is a topic or concept taxonomy, where specific items or topics are grouped into a hierarchy of items or topics. In the context of an online recommender service (generally, an online service that recommends items to a computer user based on that user's actions), understanding the context of a computer user's actions in view of a topic taxonomy, especially to items or things, significantly enhances the ability of a recommender service to recommend items that are of likely interest to that user.

Unfortunately, just as classifying a biological organism into a traditional taxonomy is difficult, time-expensive and requires substantial human-curation activity, so too is the online use of taxonomies, especially when it comes to adding an item into an existing topical taxonomy at the correct location in the hierarchy.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary segment of a taxonomic hierarchy, suitable for describing aspects of the disclosed subject matter;

FIG. 2 is a flow diagram illustrating an exemplary routine suitable for positioning a taxonomy candidate c into a taxonomic hierarchy T in accordance with aspects of the disclosed subject matter;

FIG. 3 is a flow diagram illustrating an exemplary routine suitable for training a neural network (i.e., a neural taxonomy expander) to determine projection tensors suitable for use by a projection function to project a taxonomy candidate c into an existing taxonomic hierarchy T, and identifying the candidate's likely parent within the taxonomy, in accordance with aspects of the disclosed subject matter;

FIG. 4 is a block diagram of exemplary components of a neural taxonomy expander formed in accordance with aspects of the disclosed subject matter;

FIG. 5 is a pictorial diagram illustrating elements of a neural network/machine learning model suitable for identifying the query's likely parent within the taxonomy in accordance with aspects of the disclosed subject matter;

FIG. 6 is a block diagram illustrating an exemplary computer readable medium encoded with instructions for implementing aspects of the disclosed subject matter; and

FIG. 7 is a block diagram illustrating an exemplary computing system (or computing device) suitably configured for implementing taxonomy expansion service in accordance with aspects of the disclosed subject matter.

### DETAILED DESCRIPTION

According to aspects of the disclosed subject matter, systems and methods for automatically placing a taxonomy candidate within an existing taxonomy of items and things are presented. More particularly, a neural taxonomy expander (i.e., a neural network model) is trained according to an existing, curated taxonomic hierarchy of items and things. For each node in the taxonomic hierarchy, an embedding vector is generated. A taxonomy candidate c is received, wherein the candidate is to be placed within the existing taxonomy. An embedding vector is generated for the candidate and projected by a projection function of the trained neural taxonomy expander into the taxonomic hyperspace. A set of closest neighbors to the projected embedding vector of the taxonomy candidate is identified and, from the set of closest neighbors, a closest neighbor of the set is assumed as the likely parent for the taxonomy candidate c. The taxonomy candidate c is added to the existing taxonomic hierarchy as a child to the identified parent node.

For purposes of clarity and by way of definition, the term “exemplary,” as used in this document, should be interpreted as serving as an illustration or example of something, and it should not be interpreted as an ideal or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users. Moreover, the use of the combination “and/or” with multiple items should be viewed as meaning either or both items.

By way of definition, the terms “taxonomy” and “taxonomic hierarchy” are used interchangeably. Each refers to the directed, acyclical arrangement of nodes within a graph showing the taxonomic relationship of parents to children, where child nodes are a type of their parent node, but parent nodes are not a type of any of its child nodes.

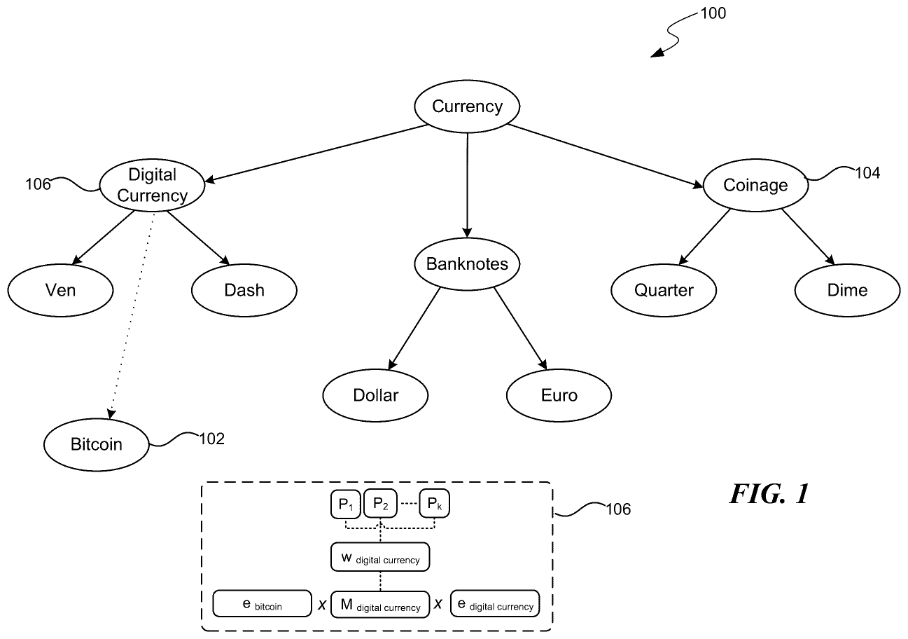

As indicated above, identifying the proper location of a new item (i.e., a taxonomy candidate c) within the hierarchy of an existing taxonomy has historically been a human-curated, time-intensive activity. By way of description and turning to the figures, FIG. 1 is a block diagram illustrating an exemplary segment of a taxonomy 100, suitable for describing aspects of the disclosed subject matter. In this example, a new item 102 (i.e., a taxonomy candidate for the existing hierarchy), corresponding to “Bitcoin,” is presented for inclusion within the taxonomy. Without knowing more, simply based on the name of the new item, “Bitcoin”, and textual content relating to taxonomy node 104, “Coinage,” the textual similarities might conclude that it makes the most sense to include the new item 102 as a child of node 104. Of course, knowing that Bitcoin is a form of digital currency, the correct parent for this new item 102 is more likely item 106, “Digital Currency.” The question becomes, how can taxonomy expansion, i.e., adding a candidate item to a correct location within an existing taxonomy, be programmatically achieved?

According to aspects of the disclosed subject matter, for a given taxonomy candidate c, i.e., where taxonomy candidate c is a new item to be added to an existing taxonomic hierarchy T, textual content regarding the candidate c is aggregated and an embedding vector e_{c} is generated from the aggregated textual content. According to various embodiments, the embedding vector e_{c} may be generated by any one of established text-based embedding vector generators, such as FastText and ConceptNet, though proprietary embedding vector generators may also be utilized.

A neural taxonomy expander is then used to project the embedding vector e_{c} into taxonomic hyperspace for the existing taxonomic hierarchy T. The neural taxonomy expander is trained to project the embedding vector e_{q} into a taxonomic hyperspace, resulting in projection p_{c}. This projection p_{c} of the embedding vector e_{c} is carried out in view of a projection tensor ϕ containing a plurality of projection matrices, the values of each projection tensor having been determined in the training of the neural taxonomy expander. After projecting the taxonomy candidate c into the taxonomic hyperspace, a set of hypernyms (parent nodes) is identified, where the set includes those nodes of the existing taxonomy T whose embedding vector eₕ is closest to the projected taxonomy candidate p_{c} within the taxonomic hyperspace. In various embodiments, this set of hypernyms is an ordered set according to their proximity to the projected query p_{c} in the taxonomic hyperspace. Typically, the closest hypernym is selected as the parent node for the taxonomy candidate c. Additional description of this process is set forth below.

According to additional aspects of the disclosed subject matter and as indicated above, the neural taxonomy expander is trained in view of an existing taxonomy T. In training the neural taxonomy expander and according to aspects of the disclosed subject matter, positive candidate/hypernym pairs {x, h} are generated from the existing taxonomy T. Additionally, in order to compensate for over-favoritism in training, negative candidate/hypernym pairs {x, h′}, where the provided hypernym h′ is not the parent of the provided candidate x, are generated in proportion to the number of child nodes of a given hypernym. These pairs, both positive and negative candidate/hypernym pairs, are randomly divided into training and validation sets. Per the discussion above, child nodes and hypernyms are projected into the hyperspace, with the embedding vector of the child node x being projecting via the projection tensor ϕ. An ordered set of hypernyms is identified for the child node x and, based on whether the pair is a positive pair, a determination is made as to whether the child node's hypernym is among the identified set of closest hypernyms. A loss function is employed to favor the identification of ordered sets in which the child node's actual hypernym or parent is among the set of hypernyms and, for negative pairs, favor the identification of ordered sets in which the supplied hypernym (of the pair) is not among the set. In processing the various pairs of the training set, the results are used to update the projection tensors in the projection tensor ϕ that transforms the pair's child node x into the taxonomic hyperspace. These updates occur upon the condition that the success of the training set has not reached a predetermined threshold. Additionally, when the neural taxonomy expander, in training, reaches that predetermined threshold, the pairs of the validation set are used to validate the training of the neural taxonomy expander or, alternatively, determine that additional training is needed. Indeed, if the success of processing the validation set fails to reach the predetermined threshold, the information of the validation set is used to update the projection tensors in the projection tensor ϕ, and the process of training the neural taxonomy expander with the training and validation sets is repeated. Of course, once validated, an executable neural taxonomy expander is generated. As those skilled in the art will appreciate, this executable neural taxonomy expander is one in which the training mechanisms are removed, leading to efficient use and execution of the trained neural taxonomy expander.

In short, item 106 of FIG. 1 illustrates at least some of the processing for determining the correct positive of the candidate node 102 (Bitcoin) in the taxonomy 100. Indeed, according to aspects of the disclosed subject matter, the process for placing a candidate c in the taxonomy 100 includes the computation, by similarity function s, of the candidate c, e.g., s(c_{bitcoin}, v_{digital currency}), to measure taxonomic relatedness. As will be discussed in greater detail below and according to various aspects of the disclosed subject matter, taxonomic relatedness is defined via linear maps P₁ . . . . Pₖ and taxonomy node embeddings w( ) e.g., w(v_{digital currency}), jointly trained to minimize large-margin ranking loss.

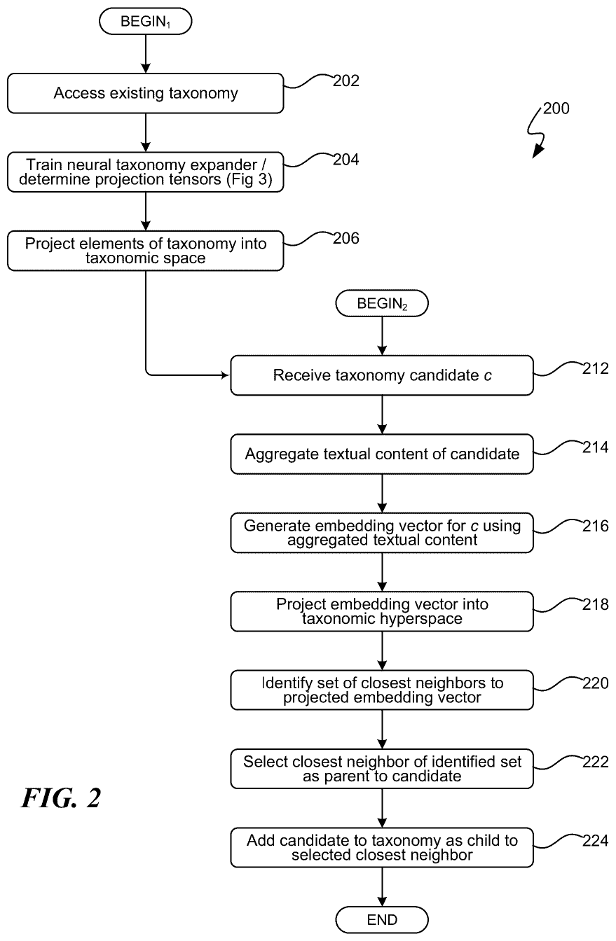

Turning to FIG. 2, FIG. 2 is a flow diagram illustrating an exemplary routine 200 suitable for positioning or placing a taxonomy candidate c into a taxonomic hierarchy, in accordance with aspects of the disclosed subject matter. For discussion and illustration purposes, the method 200 includes two beginning points: one that includes training a neural taxonomy expander for placing taxonomy candidates into an existing taxonomy, and a second that utilizes a trained neural taxonomy expander for placing taxonomy candidates into an existing taxonomy.

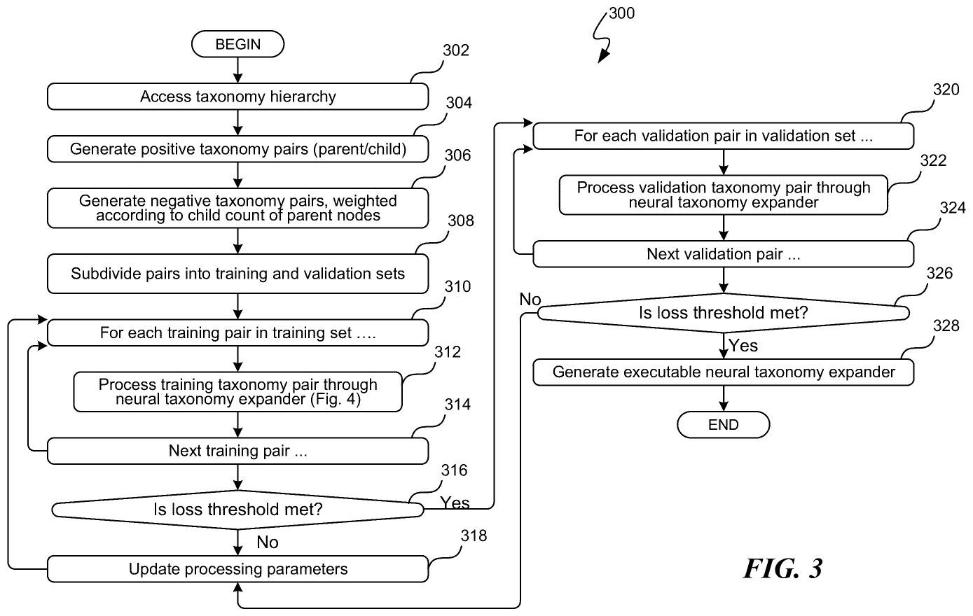

As to the first beginning point, at block 202, an existing taxonomy is accessed. According to various aspects of the disclosed subject matter, this existing taxonomy is a curated taxonomy such that the relationships (child to parent) are considered the correct relationships. In an actual embodiment, a human-curated taxonomy comprising eleven thousand nodes, arranged in a directed, acyclical graph of parent and child nodes, is used. In addition to nodes and relationship information, information regarding the existing taxonomy T is also accessed, especially including textual content associated with each node within the taxonomy. With this information, at block 204 the neural taxonomy expander is trained to project a taxonomy candidate c into the taxonomy T. Discussion of this training is set forth in greater detail below in regard to FIG. 3.

Turning to this discussion, FIG. 3 is a flow diagram illustrating an exemplary routine 300 suitable for training a neural network to determine a projection tensor ϕ of a plurality of matrices for use in a projection function suitable, for projecting a taxonomy candidate c into an existing taxonomic hierarchy T and identifying the candidate's likely parent within the taxonomy, in accordance with aspects of the disclosed subject matter. To begin, at block 302, the taxonomy T is accessed. As indicated above, the taxonomy T includes textual information associated with each node in the taxonomy. Alternatively or additionally, each node within the taxonomic hierarchy T is already associated with an embedding vector eₕ based on the node's aggregated textual content. At block 304, taxonomy pairs {x, h}, are generated from the taxonomy T, with each taxonomy pair including a child node (x) and the child's immediate parent node (h). In various instances, these taxonomy pairs may be viewed as positive taxonomy pairs, indicating that these pairs reflect the actual familial relations of the curated taxonomy, i.e., that parent node h is the immediate parent of child node x.

In addition to generating positive taxonomy pairs, at block 306 negative taxonomy pairs are also generated. In contrast to the positive taxonomy pairs, negative taxonomy pairs {x, h′} include a child node x and a hypernym node h′ that is not the child node's immediate parent. Additionally, the generation of the taxonomy pairs is weighted in a way that there are a number of negative taxonomy pairs generated for parent nodes equal or proportional to the number of actual children that a given parent node has. For example, in the taxonomy segment 100 of FIG. 1, there will be at least three negative taxonomy pairs generated for parent node 108 (Currency) since parent node 108 has three child nodes in the taxonomy. In contrast, for parent node 104 (Coinage) there will be two negative pairs generated. Of course, in various embodiments this balancing does not have to correspond to a 1:1 positive/negative pair generation. Indeed, there may be any number of multipliers for the number of pairs that are generated, e.g., 2:1 positive/negative pair generation. Further, the weighting is not required to be linear, such that for parent nodes that have more children, the increased number of negative nodes including a given parent does not need to proportionally match the negative nodes including parents with fewer child nodes.

At block 308, the taxonomy pairs, including both positive and negative taxonomy pairs, are randomly subdivided into training and validation sets. According to aspects of the disclosed subject matter, random selection ensures balanced training and proper validation of the current training of the neural network.

At block 310 an iteration loop/construct is begun to iterate through the taxonomy pairs (including both positive and negative taxonomy pairs) of the training set. At block 312, a current training taxonomy pair is processed by the neural network. Processing includes projecting an embedding vector eₓ associated with the child node x into a multi-dimensional, taxonomic hyperspace according to a projection tensor ϕ comprising a plurality of projection matrices.

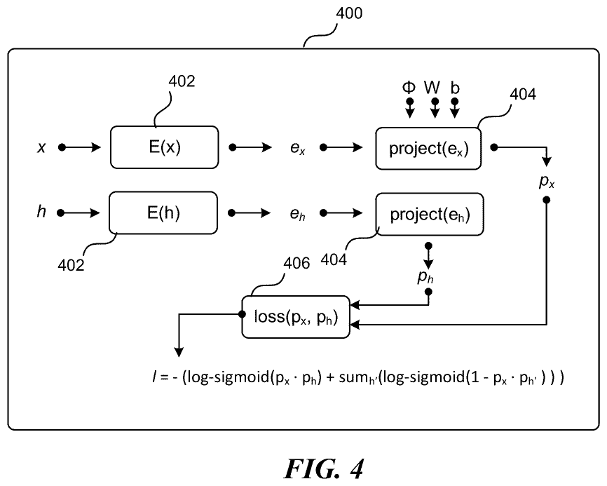

Regarding the projection tensor ϕ of matrices, according to aspects of the disclosed subject matter, each matrix is a k×D×D matrix, where k represents a desired number of projections into the multi-dimensional space by the projection function of a child node x, and D represents the number of dimensions of each embedding vector. Each projection tensor provides a type or form of weighting value used to transform or “project” the value of a corresponding dimension of the embedding vector eₓ into the multi-dimensional space. This projection process is described below in regard to the neural taxonomy expander discussed in regard to FIG. 4.

Indeed, turning to FIG. 4, this figure is a block diagram of exemplary components of a neural taxonomy expander 400 formed in accordance with aspects of the disclosed subject matter. As shown in FIG. 4, the child node x is passed to an embedding vector generator. More particularly, textual content associated with the child node x, such as content name, user comments, content title, and the like, are passed to and processed by the embedding vector generator E( ) 402 to produce an embedding vector eₓ.

The candidate's embedding vector eₓ is then projected into a taxonomic hyperspace using a projection function, project( ) 404, to produce pₓ. This projection function takes, as additional input, ϕ (the projection tensor) corresponding to a plurality of k×D×D matrices, with k corresponding to a predetermined number of projections, and D corresponding to the dimensionality of the embedding vectors (e.g., eₓ). Additionally, W corresponds to a 1×k affine matrix, and b corresponds to a 1×D affine matrix. The projections are then processed by a loss function l 406, according to the formula:

$$l = - ( log - sigmoid ( {p}_{x} \cdot {p}_{h} ) + {sum}_{{h}^{′}} ( log - sigmoid ( 1 - {p}_{x} \cdot {e}_{{h}^{′}} ) ) ) .$$

The output of this formula is used to determine whether a predetermined accuracy or loss threshold has been met in the training.

Regarding the loss function l 406, according to aspects of the disclosed subject matter and as suggested in the formula illustrated above, this loss function is computed as the sum of two components. The first component (log-sigmoid (pₓ·pₕ)) encourages the child node's projection pₓ to be similar to its actual parent embedding vector eₕ. The second component (sum_{h′}(log-sigmoid(1−pₓ·p_{h′}))) encourages the child node's projection to be dissimilar from negatively sampled parent embedding vectors, e_{h′}. Additionally, the projection tensors of ϕ are initialized as zero-mean Gaussian tensors, ensuring that initially, every projected child node x is slightly noise tolerant of its original embedding.

In regard to measuring the accuracy (i.e., the predetermined loss threshold) for the loss function l 406, for each child node x, the neural taxonomy expander is configured to select the 15 most likely parents (or hypernyms). According to aspects of the disclosed subject matter, this set of likely parents may be ranked in order of their closeness to the projected child node pₓ. In various embodiments, this likelihood is determined according to a cosine similarity of the projected child node pₓ in view of the hypernym embedding vectors in the taxonomic hyperspace, based on all of the dimensions of the embedding vectors.

To determine metrics of the projections, and according to aspects of the disclosed subject matter, a Mean Reciprocal Rank (MRR) is generated for each pair. More particularly, a reciprocal rank is determined for each child/hypernym pair according to the position of the actual parent of the child node in the set of likely hypernyms. For example, assume that the projected output for child node x is the set {h₁, h₂, h₃, h₄, and h₅}. In this set, while denoted as h₁, h₂, h₃, etc., the actual parent for the child node x may be none or all of the hypernyms, meaning that h₁ may be equal to h₂, etc. The reciprocal rank is determined according to position of the first actual parent. In this example, assume that the actual parent for child node x is both h₂ and h₃. Thus, for this child node x, the reciprocal rank is 0.5. In the event that the actual parent for the child node x is not within the set, the reciprocal rank is zero (0). The averaged reciprocal ranks for each of the child/hypernym pairs is determined to generate an MRR. As suggested above, the MRR rewards the instance in which non-parents for a child node x are predicted with low probability.

In addition to generating the MRR for the set of pairs, a Mean Average Precision (MAP) is also generated. An average precision (AP) is generated for each pair. This average precision is dependent on whether each instance of the actual parent is identified. In the example above, if the actual parent for the child node x is h₂ and h₃, and both are identified in the resulting set, the average precision is 2/2 or 1.0. The map is the mean for the AP's over all child nodes. According to aspects of the disclosed subject matter, both the MRR and the MAP are used in determining the performance metrics of the neural taxonomy expander to identify whether a loss threshold is met during training.

Returning back to FIG. 3, after having processed the current training pair, at block 314 the iteration process returns to block 310 to process the next training pair, if there are more training pairs to process. In the alternative, if there are no more training pairs to process, the routine 300 proceeds to decision block 316.

At decision block 316, a determination is made as to whether the accuracy/of the most recent processing with the training set has achieved a threshold level of accuracy. If the threshold level of accuracy is not met, the routine 300 proceeds to block 318 where the processing parameters, particularly the projection tensors, are updated in view of the accuracy results of the previous training period. Thereafter, the routine 300 returns to block 310 to again process the training pairs. This repetitive training process continues until, at decision block 316, the accuracy threshold is met.

Once the accuracy threshold is met, the routine 300 proceeds to block 320. In similar manner to the processing of training pairs, at block 320 an iteration loop is begun to iterate through the validation pairs. Thus, at block 322, a current validation pair is processed, and the accuracy of the projection is recorded. At block 324, if there are additional validation pairs to process, the routine 300 returns to block 320. Alternatively, if there are no additional validation pairs to process, the routine proceeds to decision block 326.

At decision block 326, a determination is made as to whether the predetermined loss threshold/accuracy threshold is met. If not, the routine 300 returns to block 318 where the processing parameters are updated. Thereafter, the routine 300 proceeds to block 310 to continue the training of the neural network with the training pairs. In the alternative, at decision block 326, if the threshold loss level/accuracy level is met, the routine proceeds to block 328 where an executable version of the now-trained neural taxonomy expander is generated for use in expanding the accessed taxonomy. Thereafter, routine 300 terminates.

Returning again to routine 200, once the neural taxonomy expander is generated, a new begin location is used, beginning at block 212. At block 212, a taxonomy candidate c is received, where c is to be placed in the existing taxonomy. At block 214, the textual content relating to taxonomy candidate c is aggregated. According to aspects of the disclosed subject matter, this textual content may include any one or more of a title associated with the content item, captions associated with the content item, collection titles and/or captions in which the content item is a member, a URL (uniform resource locator) or URI (uniform resource identifier) associated with the content item, user comments made in regard to the content item, the subject matter of the content item, and the like.

After aggregating textual content relating to the taxonomy candidate, at block 216 an embedding vector, e_{c}, is generated for the candidate. In various embodiments, the embedding vector, e_{c}, is generated by a third-party embedding vector generator, such as FastText or ConceptNet. At block 218, the taxonomy candidate's embedding vector e_{c} is then projected into the taxonomic hyperspace (i.e., the multi-dimensional space) using the projection tensors learned/trained during the training of the neural taxonomy expander.

At block 220, a set of closest neighbors in the taxonomic hyperspace is identified, where this set of closest neighbors represents the most likely parents of the taxonomy candidate c. According to aspects of the disclosed subject matter, this set of closest neighbors is an ordered list, ordered according to their closeness to the projected taxonomy candidate in the taxonomic hyperspace and representing the likelihood of the node being the parent. At block 222, the closest neighbor from the set is selected as the parent of the taxonomy candidate c. In various embodiments, the determination of closest neighbor (or closest neighbors) to the projected taxonomy candidate p_{c} may be made according to a cosine similarity evaluation of the projected vectors of both the taxonomy candidate and existing taxonomy nodes into the taxonomic hyperspace. At block 224, the taxonomy candidate c is added to the taxonomy with the selected parent as its parent.

Optionally, the candidate and the set of closest neighbors may be evaluated to determine the accuracy of the neural taxonomy expander. Metrics such as mean reciprocal rate (MRR) and mean average precision (MAP) may be determined to see whether the neural taxonomy expander is performing at an acceptable threshold level, which may lead to new training of the neural taxonomy expander as discussed in regard to FIG. 3.

Thereafter, routine 200 terminates.

In regard to the identification of likely neighbors to a taxonomy candidate c in an existing taxonomy, and in regard to training the neural taxonomy expander, in a general sense the effort is to determine a similarity function s that determines the similarity of the taxonomy candidate c to existing interest nodes in the existing interest taxonomy. Generally speaking, this similarity function can be described in formula as:

$$s ( c , v ) = ( {e}_{c} {M}_{v} ) \cdot {e}_{v}$$

where c represents the taxonomy candidate to be added to the taxonomy, v represents an existing interest node in the interest taxonomy (in consideration as a potential parent node for taxonomy candidate c), e_{c} is the embedding vector for the taxonomy candidate c, eᵥ is the embedding vector for the interest node v, and M is a linear transformation of the taxonomic relationships of the interest taxonomy in the embedding space of the interest nodes (and taxonomy candidate c) of the interest taxonomy.

This generalized formula works fine until the interest taxonomy includes child nodes that have relationships to multiple parents. For example, if an interest node in the interest taxonomy was “Thanksgiving”, it is entirely conceivable that this interest node would have multiple parent nodes including “US Holidays” and “Meals.” To address this, rather than having a single linear transformation M, a linear transformation of the taxonomic relationships for each interest/parent node v is generated. The resulting modification to the similarity function s is as follows:

$$s ( c , v ) = ( {e}_{c} {M}_{v} ) \cdot {e}_{v}$$

where Mᵥ is the linear transformation specific to interest node v.

One of the issues in this updated formula is the number of linear transformations Mᵥ that are generated, greatly impacting the amount of training that must occur to fully train the neural taxonomy expander 400. To mitigate this problem, we can exploit the fact that the number of distinct edge semantics (child to parent relationships) is much smaller than the possible number, i.e., any given child/interest node in the interest taxonomy will not have a relationship to ALL other interest nodes in the taxonomy, but rather a small number of parent/interest nodes. In this, we assume that there are k edge semantics (relationships) for a given interest node and define each linear map Mᵥ as a weighted combination of k linear maps, P₁-Pₖ, that are shared across all taxonomy nodes:

$${M}_{v} = {\sum }_{i = 1}^{k} sparsemax ( {w}_{v} ) [ i ] x {P}_{i}$$

where wᵥ represents an embedding vector of interest node v to be learned, and the sparsemax( ) function transforms the embedding into a sparse probability distribution. This transformation into the sparse probability distribution encourages the neural taxonomy expander to allocate weight to a few of the k potential edge semantics and reduces the number of parameters that must be considered without fragmenting the training data.

Taxonomic similarity or relatedness defined as such implies a modeling decision: all the incoming edges from the children of any interest node v share the same semantics, as represented by Mᵥ, and driven by its embedding vector wᵥ. In short, the embedding of a given interest node v captures its taxonomic role in the overall interest taxonomy. Advantageously, this allows interest nodes to be linguistically dissimilar but share similar taxonomic roles.

According to aspects of the disclosed subject matter, in order to rank the interest nodes for a given taxonomy candidate c, such that the true parent/interest node in the interest taxonomy of the taxonomy candidate c is ranked higher than other interest nodes, the neural taxonomy expander 400 is trained to identify child-parent relatedness or similarity by a wide margin over other candidate parent nodes. Formally, this goal is to satisfy the following constraint for every child-parent pair (c, v):

$$s ( c , v ) \geq s ( c , {v}^{′} ) + γ ( c , v , {v}^{′} )$$

where v′ represents an interest node of the interest taxonomy that is not the true parent/interest node (v) of taxonomy candidate c, and the function γ(c, v, v′) represents a desired margin of difference in the predicted similarities of (c, v) and (c, v′). To this end, an error function ξ(c, v, v′) is defined to satisfy the large margin constraint, denoting the degree to which a non-parent/interest node v′ violates the large-margin constraint of child-parent pair (c, v):

$$ℰ ( c , v , {v}^{′} ) = max [ 0 , s ( c , {v}^{′} ) - s ( c , v ) + γ ( c , v , {v}^{′} ) ]$$

In this, when the large-margin constraint is satisfied, ξ(c, v, v′)=0. In the alternative, when the large-margin constraint is not satisfied, ξ(c, v, v′)>0.

According to aspects of the disclosed subject matter, with the error function ξ(c, v, v′) defined, we derive a loss function L(T) as the total violation of the large-margin constraints by the non-parent/interest nodes corresponding to every child-parent pair (c, v):

$$L ( T ) = {\sum }_{( c , v ) ∈ E} {\sum }_{{v}^{′} ∈ V - H ( c )} ℰ ( c , v , {v}^{′} )$$

where E represents a set of all child-parent nodes in the interest taxonomy, V represents a set of all parent nodes of the interest taxonomy, and H(c) represents the actual set of parents for taxonomy candidate c. This leads to the proposition that when γ(c, v, v′) is equal to d(v, v′), where d(*, *) represents the shortest path between two interest nodes in the taxonomy, the loss function L(T) is an upper-bound on the sum of the undirected shortest-path distances between the highest-ranked predicted parent/interest nodes and the true parent/interest node according to the formula:

$${\sum }_{( c , v ) ∈ E} d ( v , v \hat{} ( c ) ) \leq L ( T )$$

where v\hat{ }(c) represents the highest-ranked predicted parent for taxonomy candidate c.

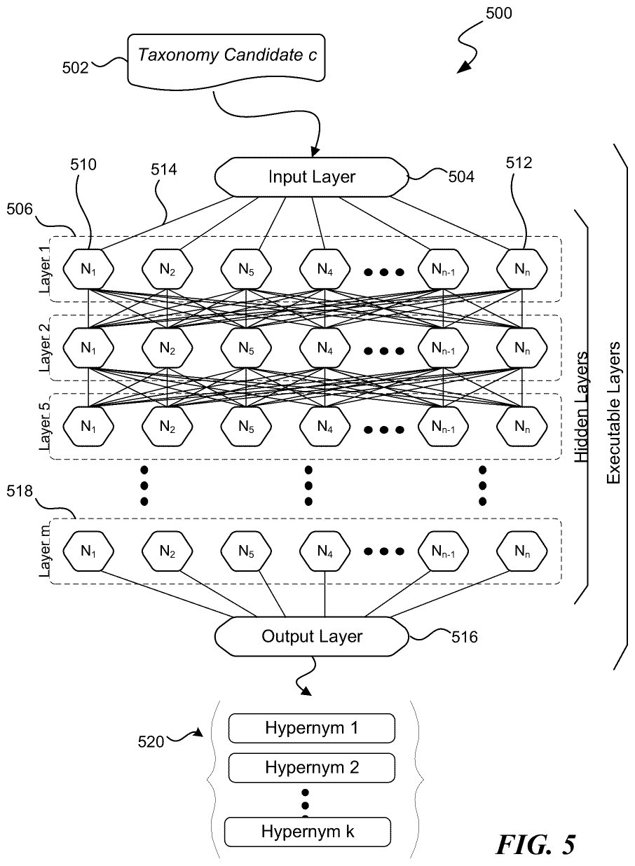

Regarding the training of the neural taxonomy expander 400 discussed above, reference is now made to FIG. 5. Indeed, FIG. 5 is a pictorial diagram illustrating elements of a neural network 500 (sometimes also referred to as a machine learning model) suitable for training as a neural taxonomy expander in identifying a parent node (also called a hypernym) in an existing taxonomy for a given taxonomy candidate c, in accordance with aspects of the disclosed subject matter.

As those skilled in the art will appreciate, a neural network 500 comprises multiple executable layers, including an input layer 504, an output layer 516, and one or more hidden layers. By way of illustration, the neural network 500 includes m hidden layers, including hidden layers 506 and 518. The input layer 504 accepts the input data (e.g., input from taxonomy candidate 502) for which the neural network 500 will identify one or more likely hypernyms.

The input layer 504 accepts the input data, in this illustrated instance taxonomy candidate 502, any metadata that may be associated with the input item and/or textual content and, according to one or more predetermined algorithms and/or heuristics, generates a plurality of values for one or more aspects, features and/or facets from the input. These values, not shown in FIG. 5 but implied by the various edges, such as edge 514, extending from the input layer 504 to the various processing nodes of the first hidden layer 506, constitute at least some of the output of the input layer and are distributed as input data or input values to processing nodes of the first hidden layer of the neural network 500, such as processing nodes 510 and 512.

Typically, though not exclusively, a value or facet of the input data passed from the input layer 504 to a first processing node in the first hidden layer, such as node 510 of hidden layer 506, is different than a value/facet passed to a second processing node of that same hidden layer, such as to node 512 of hidden layer 506.

Each hidden layer, including hidden layers 506 and 518, comprises a plurality of processing or projection nodes. By way of illustration and not limitation, hidden layer 506 includes n processing nodes, N₁-Nₙ. While the processing nodes of the first hidden layer 506 typically, though not exclusively, have a single input value from the input layer 504, processing nodes of subsequent hidden layers typically have input values from one or more processing nodes of the previous input layer. Of course, in various embodiments the processing nodes of the first hidden layer 506 may receive, as input values, all output values of the input layer 504.

In various embodiments and as illustrated in the executable neural network 500, each hidden layer (except for the first hidden layer 506) accepts input data/signals from each processing node of the prior hidden layer, as indicated by the edges proceeding from a processing node of an “upper” hidden layer (e.g., layer 506) to a “lower” hidden layer. Of course, alternative embodiments need not include such wide distribution of output values to the processing nodes of a subsequent, lower level.

Each processing node implements one or more “convolutions,” “computations” or “projections” on the input data it receives (whether the processing node receives a single item of input data, or plural items of input data) to produce a single output value. These convolutions, projections, and/or computations may include any number of functions or operations to generate the output data such as, by way of illustration and not limitation, data aggregations, clustering various input values, transformations of input values, combination of plural input values, selections and/or filters among input values, mathematical manipulations of one or more input values, linear and/or multivariate regressions of the input values, statistical determinations of the input values, predictive evaluations, and the like. Moreover, individual items of input data may be weighted in any given processing node such that the weighted input data plays a greater or lesser role in the overall computation for that processing node. Items of input data may be weighted in such a manner as to be ignored in the various convolution and computations. Hyperparameters (data/values that are input from sources external to processing nodes of a prior input level) may also be utilized by all or some of the processing nodes of a hidden layer.

As will be appreciated by those skilled in the art, one of the interesting aspects of machine learning/neural networks is that the various executable levels are adaptable to accommodate self-learning. In other words, when provided feedback, modifications may be made to the weights, parameters, and processing operations of the processing nodes in the various layers, in order to achieve better results. These modifications include modifications to the matrices of projection tensor ϕ used to map items into the taxonomic hyperspace. Due to this adaptability, except for initially established computations of the various processing nodes in a training phase of the machine learning process, a person is unlikely to have specific insight or knowledge as to the exact nature of output values and, correspondingly, the exact nature of convolutions and/or computations that any particular processing node of a hidden layer may utilize. Instead, during the training process of a machine learning process, the machine learning process makes its own determinations as to how to modify each computation of a given processing node to produce better/superior results for the input values it receives.

At the final hidden layer, e.g., layer 518, the processing nodes provide their output data to the output layer 516. The output layer 516 performs whatever final aggregations, calculations, transformations, projections, normalizations and/or interpretations of the various items of input data to produce a set 520 of one or more output values corresponding to the most likely hypernyms for the taxonomy candidate 502.

Regarding routines 200 and 300 described above, as well as other routines and/or processes described or suggested herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only or best order in which the steps may be carried out. Moreover, in some instances, some of these steps may be combined and/or omitted. Optimizations of routines may be carried out. Those skilled in the art will recognize that the logical presentation of steps is sufficiently instructive to carry out aspects of the claimed subject matter irrespective of any specific or particular development or coding language in which the logical instructions/steps are encoded. Additionally, while some of these routines are expressed in the context of recursive routines, those skilled in the art will appreciate that such recursive routines may be readily implemented as non-recursive calls without actual modification of the function or result. Accordingly, the particular use of programming and/or implementation techniques and tools to implement a specific or particular functionality should not be construed as limiting upon the disclosed subject matter.

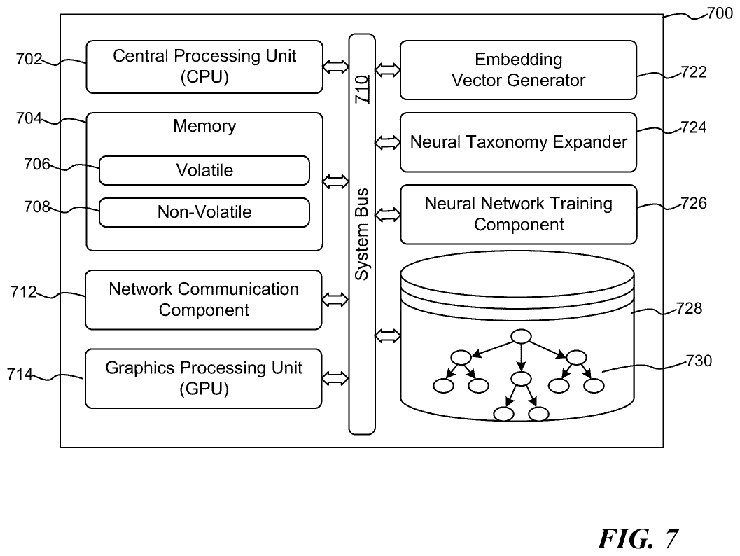

Of course, while these routines and/or processes include various novel features of the disclosed subject matter, other steps (not listed) may also be included and carried out in the execution of the subject matter set forth in these routines, some of which have been suggested above. Those skilled in the art will appreciate that the logical steps of these routines may be combined or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in FIG. 7 below. Additionally, in various embodiments all or some of the various routines may also be embodied in executable hardware modules including, but not limited to, systems on chips (SoC's), codecs, specially designed processors and or logic circuits, and the like.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in executable instructions embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer readable media include but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer readable media may reproduce and/or cause to deliver the computer executable instructions and data to a computing device for execution by one or more processors via various transmission means and mediums, including carrier waves and/or propagated signals, for purposes of this disclosure computer readable media expressly excludes carrier waves and/or propagated signals.

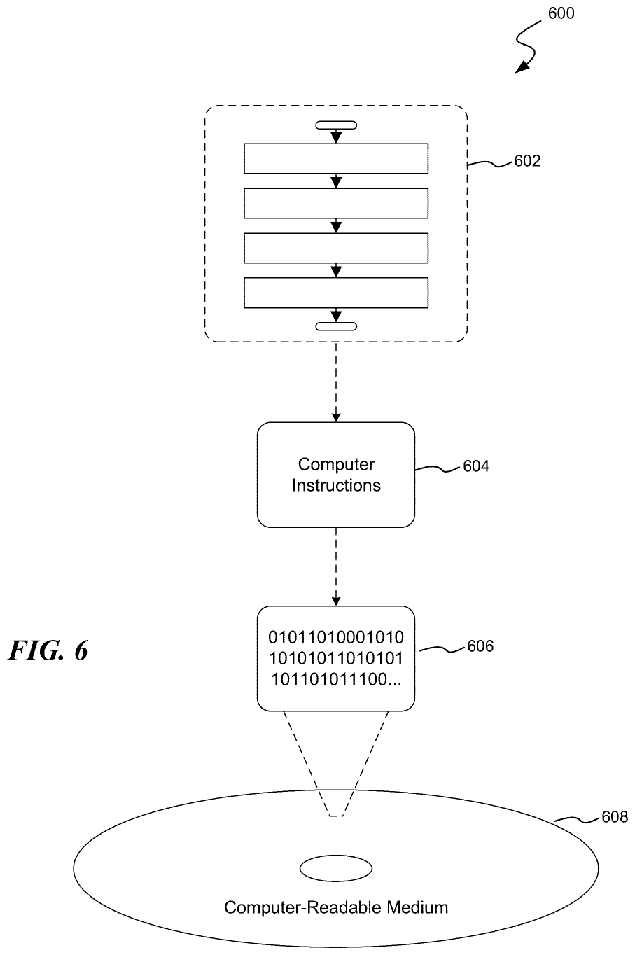

Regarding computer readable media, FIG. 6 is a block diagram illustrating an exemplary computer readable medium encoded with instructions for implementing aspects of the disclosed subject matter. More particularly, the implementation 600 comprises a computer-readable medium 608 (e.g., a CD-R, DVD-R or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of exemplary routine 200 and 300, for example. In another such embodiment, the processor-executable instructions 604 may be configured to implement a system on a computing device, such as at least some of the exemplary, executable components of computing device 700 of FIG. 7, as described below. Many such computer readable media may be devised, by those of ordinary skill in the art, which are configured to operate in accordance with the techniques presented herein.

Turning to FIG. 7, FIG. 7 is a block diagram illustrating an exemplary computing system 700 (also referred to as a computing device) suitably configured for implementing a neural taxonomy expander in accordance with aspects of the disclosed subject matter. The computing system 700 typically includes one or more central processing units (or CPUs), such as CPU 702, and further includes at least one memory 704. The CPU 702 and memory 704, as well as other components of the computing system, are interconnected by way of a system bus 710.

As will be appreciated by those skilled in the art, the memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. In general, RAM and CPU cache memory are examples of volatile memory 706 whereas ROM, solid-state memory devices, memory storage devices, and/or memory cards are examples of non-volatile memory 708.

As will be further appreciated by those skilled in the art, the CPU 702 executes instructions retrieved from the memory 704, from computer readable media, such as computer readable media 608 of FIG. 6, and/or other executable components in carrying out the various functions of the disclosed subject matter. The CPU 702 may be comprised of any of a number of available processors such as single-processor, multi-processor, single-core units, and multi-core units, which are well known in the art.

Further still, the illustrated computing system 700 typically also includes a network communication interface 712 for interconnecting this computing system with other devices, computers and/or services over a computer network. The network communication interface 712, sometimes referred to as a network interface card or NIC, communicates over a network using one or more communication protocols via a physical/tangible (e.g., wired, optical fiber, etc.) connection, a wireless connection such as WiFi™ or Bluetooth™ communication protocols, NFC, or a combination thereof. As will be readily appreciated by those skilled in the art, a network communication interface, such as network communication component 712, is typically comprised of hardware and/or firmware components (and may also include or comprise executable software components) that transmit and receive digital and/or analog signals over a transmission medium (i.e., the network).

The illustrated computing system 700 also includes a graphics processing unit (GPU) 714. As those skilled in the art will appreciate, a GPU is a specialized processing circuit designed to rapidly manipulate and alter memory. Initially designed to accelerate the creation of images in a frame buffer for output to a display, due to their ability to manipulate and process large quantities of memory, GPUs are advantageously applied to training machine learning models and/or neural networks that manipulate large amounts of data. Indeed, one or more GPUs, such as GPU 714, are often viewed as essential processing components when conducting machine learning techniques. Also, and according to various embodiments, while GPUs are often included in computing systems and available for processing convolutions of machine learning models, such as GPU 714 of computing system 700, multiple GPUs are also often deployed as online GPU services or farms and machine learning processing are advantageously directed to conducting the various layers/convolutions of training a neural network.

The illustrated computing system 700 additionally includes an embedding vector generator 722. As those skilled in the art will appreciate, an embedding vector is an array or vector of values, each value corresponding to some particular aspect of the source item. According to aspects of the disclosed subject matter, an embedding vector for a taxonomy candidate is generated from aggregated textual content relating to the candidate. Often this type of embedding vector is referred to as a word embedding vector. In various embodiments of the disclosed subject matter, the embedding vector generator 722 may be configured to generate its own embedding vectors for input items or, in the alternative, obtain an embedding vector already configured for that purpose. At least one common embedding vector generator is the concept.net embedding vector.

Further still, the illustrated computing system 700 includes a neural taxonomy expander 724. As discussed above in regard to routine 200, the neural taxonomy expander 724, once trained, is configured to receive a taxonomy candidate and identify an ordered set of one or more hypernyms and use the most likely hypernym as the parent for the taxonomy candidate. The taxonomy candidate is then added to the taxonomy 730, as may be stored in a data store 728 by the computing system 700.

Regarding the neural taxonomy expander 724, the computing system 700 also includes a neural network training component 726 suitably configured to train the neural taxonomy expander. As suggested above in regard to routine 300 of FIG. 3, the neural network training component 726 accesses an existing taxonomy 728, generates taxonomy pairs and uses these pairs to train the neural taxonomy expander 724 to identify the most likely parent for a given taxonomy candidate c.

Regarding the various components of the exemplary computing device 700, those skilled in the art will appreciate that many of these components may be implemented as executable software modules stored in the memory of the computing device, as hardware modules and/or components (including SoCs-system on a chip), or a combination of the two. Indeed, components may be implemented according to various executable embodiments including, but not limited to, executable software modules that carry out one or more logical elements of the processes described in this document, or as hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method, comprising:
receiving a taxonomy candidate;
aggregating textual content associated with the taxonomy candidate;
generating, based at least in part on the aggregated textual content, an embedding vector that is representative of the taxonomy candidate;
projecting, using a neural taxonomy expander, the embedding vector into a taxonomic hyperspace of an existing taxonomy, wherein the neural taxonomy expander includes a neural network trained using a dataset having a plurality of candidate/hypernym pairs, the candidate/hypernym pairs generated from the existing taxonomy and the neural taxonomy expander including a projection tensor configured to project an input into the taxonomic hyperspace;
determining, based at least in part on a set of neighbors to the projection of the embedding vector in the taxonomic hyperspace, a parent node for the taxonomy candidate; and
adding the taxonomy candidate to the existing taxonomy as a child node of the parent node.

2. The computer-implemented method of claim 1, wherein the aggregated textual content associated with the taxonomy candidate includes at least one of:
a title associated with the taxonomy candidate;
a caption associated with the taxonomy candidate;
a collection title of a collection of which the taxonomy candidate is a member;
a uniform resource locator (URL) associated with the taxonomy candidate;
a uniform resource identifier (URL) associated with the taxonomy candidate; or
a user comment associated with the taxonomy candidate.

3. The computer-implemented method of claim 1, wherein:
the plurality of candidate/hypernym pairs includes a plurality of positive candidate/hypernym pairs and a plurality of negative candidate/hypernym pairs;
each of the plurality of negative candidate/hypernym pairs includes a negative parent node; and
a first number of the plurality of negative candidate/hypernym pairs that includes the negative parent node is proportional to a second number of immediate children of the negative parent node.

4. The computer-implemented method of claim 1, wherein the set of neighbors includes an ordered list of closest neighbors to the projection of the embedding vector in the taxonomic hyperspace.

5. The computer-implemented method of claim 4, wherein the ordered list of closest neighbors is determined based at least in part on a cosine similarity of each of the ordered list of closest neighbors to the projection of the embedding vector in the taxonomic hyperspace.

6. The computer-implemented method of claim 1, further comprising:
training the neural taxonomy expander, wherein training the neural taxonomy expander includes:
generating, based at least in part on a plurality of nodes of the existing taxonomy, the plurality of candidate/hypernym pairs; and
projecting, using the projection tensor, a child node of each of the plurality of candidate/hypernym pairs into a taxonomic hyperspace;
determining, for each child node and based at least in part on the projection into the taxonomic hyperspace, a respective set of candidate parents; and
determining a loss by applying a loss function to the projection of the child node and the respective sets of candidate parents; and
updating the neural taxonomy expander based at least in part on the respective sets of candidate parents determined for each child node until the loss achieves a loss threshold.

7. The computer-implemented method of claim 6, wherein determining the respective set of candidate parents for each child node includes determining a similarity between each child node and the respective set of candidate parents.

8. The computer-implemented method of claim 7, wherein determining the similarity includes using a similarity function that includes a multi-linear transformation term for each candidate parent node of the respective set of candidate parents.

9. The computer-implemented method of claim 8, wherein the multi-linear transformation term for each candidate parent node includes a weighted combination of a plurality of linear maps that is based at least in part on a number of edges associated each candidate parent node.

10. The computer-implemented method of claim 6, wherein updating the neural taxonomy expander includes updating the projection tensors.

11. The computer-implemented method of claim 6, wherein determining the loss includes determining at least one of a mean reciprocal rank or a mean average precision.

12. The computer-implemented method of claim 6, wherein the loss function:
encourages first child nodes of positive candidate/hypernym pairs to be similar to first parent nodes of the positive candidate/hypernym pairs; and
encourages second child nodes of negative candidate/hypernym pairs to be dissimilar to second parent nodes of the negative candidate/hypernym pairs.

13. A computing system, comprising:
one or more processors; and
a memory storing program instructions that, when executed by the oner or more processors, cause the one or more processors to at least:
generate an embedding vector for a taxonomy candidate, wherein the embedding vector represents an aggregation of textual content associated with the taxonomy candidate;
project, using a neural taxonomy expander, the embedding vector into a taxonomic hyperspace of an existing taxonomy, wherein the neural taxonomy expander includes a neural network trained using a dataset having a plurality of taxonomy pairs, the plurality of taxonomy pairs generated from the existing taxonomy and the neural taxonomy expander including a projection tensor configured to project an input into the taxonomic hyperspace;
determine, based at least in part on the projection of the embedding vector in the taxonomic hyperspace, a set of neighbor nodes for the taxonomy candidate;
determine a parent node from the set of neighbor nodes; and
add the taxonomy candidate to the existing taxonomy as a child node of the parent node.

14. The computing system of claim 13, wherein:
the memory includes further program instructions that, when executed by the one or more processors, further cause the one or more processors to at least aggregate a plurality of textual information associated with the taxonomy candidate a title associated with the taxonomy candidate; and
the plurality of textual information includes at least one of:
a caption associated with the taxonomy candidate;
a collection title of a collection of which the taxonomy candidate is a member;
a uniform resource locator (URL) associated with the taxonomy candidate;
a uniform resource identifier (URL) associated with the taxonomy candidate; or
a user comment associated with the taxonomy candidate.

15. The computing system of claim 13, wherein:
the plurality of taxonomy pairs includes a plurality of positive taxonomy pairs; and
each of the plurality of positive taxonomy pairs includes a respective child node and a corresponding parent node that is an immediate parent node of the respective child node.

16. The computing system of claim 13, wherein:
the plurality of taxonomy pairs includes a plurality of negative taxonomy pairs; and
each of the plurality of negative taxonomy pairs includes a respective child node and a corresponding parent node that is a not immediate parent node of the respective child node.

17. The computing system of claim 16, wherein a first number of the plurality of negative taxonomy pairs that includes the negative parent node is proportional to a second number of immediate children of the negative parent node.

18. The computing system of claim 13, wherein determining the set of neighbor nodes for the taxonomy candidate is based at least in part on a similarity between the projection of the embedding vector and the set of neighbor nodes.

19. The computing system of claim 18, wherein the similarity is determined using a similarity function that includes a corresponding multi-linear transformation term for each neighbor node of the set of neighbor nodes.

20. A non-transitory computer-readable medium storing program instructions thereon that, when executed by one or more processors, cause the one or more processors to perform steps, comprising:
aggregating textual content associated with a taxonomy candidate;
projecting, using a neural taxonomy expander, an embedding vector that is representative of the taxonomy candidate and generated based at least in part on the aggregated textual content into a taxonomic hyperspace of an existing taxonomy, wherein the neural taxonomy expander includes a neural network trained using a dataset having a plurality of taxonomy pairs, the plurality of taxonomy pairs generated from the existing taxonomy and the neural taxonomy expander including a projection tensor configured to project an input into the taxonomic hyperspace;
determining, based at least in part on the projection of the embedding vector in the taxonomic hyperspace, a set of nearest neighbor nodes for the taxonomy candidate;
determining a parent node from the set of nearest neighbor nodes; and
adding the taxonomy candidate to the existing taxonomy as a child node of the parent node.
